(19) United States
(12) Patent Application Publication
(10) Pub. No.: US 2020/0072266 A1
(43) Pub. Date: Mar. 5, 2020

(54) METAL JOINING STRUCTURE AND METAL WELDING METHOD

(71) Applicant: EAGLE INDUSTRY CO., LTD., MINATO-KU, TOKYO (JP)

(72) Inventors: Hiroshi MIYASHIRO, Minato-ku, Tokyo (JP); Norimitsu AKIYOSHI, Minato-ku, Tokyo (JP); Makoto MITSUYASU, Minato-ku, Tokyo (JP)

(21) Appl. No.: 16/607,684

(22) PCT Filed: May 14, 2018
(86) PCT No.: PCT/JP2018/018622

§ 371 Date: Oct. 23, 2019

(30) Foreign Application Priority Data
May 22, 2017 (JP) 2017-100606

(51) Int. Cl. F16B 5/08; B23K 26/28

(52) U.S. Cl. CPC F16B 5/08; B23K 26/28

(57) ABSTRACT

In an exemplary welding method for joining at least a first member and a second member made of metals by fiber laser welding, the fiber laser welding forms welding lines 16, 19 by sequentially irradiating a laser light L while moving along annular scheduled welding lines 13, 18 and vibrating across the scheduled welding lines 13, 18, whereby the resultant metal joining structure secures a welding area of the metal members and has high strength and durability.

### TECHNICAL FIELD

The present invention relates to a metal joining structure and a metal welding method, and particularly relates to a metal bellows in which a plurality of element members are integrated by welding airtightly and telescopically and a manufacturing method of a metal bellows.

### BACKGROUND ART

Conventionally, a metal bellows is used in a wide range of fields such as an accumulator, a semiconductor manufacturing equipment, a piping joint, and a coupler. As a method of manufacturing a metal bellows by welding, for example, annular thin metal plates are laminated, and inner circumferential edges and outer circumferential edges of the metal plates of the respective adjoining layers are alternately welded and joined (See Patent Documents 1-3).

### CITATION LIST

### Patent Document

Patent Document 1: JPH09-216054 A (Page 2-3, FIG. 1)

Patent Document 2: JP 2004-162728 A (FIG. 4)

Patent Document 3: JP 2012-26554 A (FIG. 7)

### SUMMARY OF INVENTION

### Technical Problem

However, in the manufacturing methods of Patent Documents 1-3, the inner circumferential edges and the outer circumferential edges of the metal plates of the respective adjoining layers are alternately welded from the outside in a radial direction by a welding machine, and therefore welded parts are linear and it is difficult to increase the area of the welded parts. Therefore, it was troublesome to manufacture a high strength metal bellows.

In order to solve the above-mentioned problem, an object of the present invention is to provide a metal joining structure which secures a welding area of metal members and has high strength and durability, and a metal welding method.

### Solution to Problem

In order to solve the problem, a metal welding method according to a first aspect of the present invention is a welding method for joining at least a first member and a second member made of metals by using a fiber laser welding means, the welding method is characterized in that the welding means forms welding lines by sequentially irradiating a laser light while moving along annular scheduled welding lines and vibrating across the scheduled welding lines.

According to the first aspect, the welding means forms the welding lines while moving along the scheduled welding line and vibrating across the welding lines, and therefore a radial length of the welding lines can be set freely, a planar joined part having desired shape and area can be formed, and the scheduled welding lines are surely welded. Further, even if welding distortion occurs in the periphery of a laser light irradiation place where a laser light is irradiated once, the welding distortion in the periphery of the irradiation place is resolved by being heated again by irradiation of a laser light with respect to the vicinity of the laser light irradiation place, and more excellent welding strength can be secured. Moreover, the annular scheduled welding lines are formed, and therefore it is possible to provide a metal welding method which can exhibit high strength and durability without directionality even if a force acts from any direction with respect to a welded part.

The metal welding method according to a second aspect of the present invention is characterized in that the welding means is a single-mode fiber laser.

According to the second aspect, the single-mode fiber laser can extremely narrow down the size of a beam spot and focus on one point, and therefore a heat gain in the beam spot can be secured without excessively increasing laser output, and distortion can be prevented from occurring even if its thickness is thin.

The metal welding method according to a third aspect of the present invention is characterized in that, in a direction along the scheduled welding lines, the adjoining welding lines come into contact or overlap with each other.

According to the third aspect, the adjoining welding lines are reinforced by overlapping with each other, thereby capable of exhibiting sufficient welding strength.

The welding method according to a fourth aspect is characterized in that the first member and the second member are members of an annular thin plate which are alternately laminated, and the scheduled welding lines are set in an overlapping part of the adjoining first member and second member.

According to the fourth aspect, it is possible to suppress welding distortion even in a thin plate while forming a welded part having desired welding area and welding shape.

The welding method according to a fifth aspect of the present invention is characterized in that the first member and the second member are conductors, and the scheduled welding lines are set in an overlapping part of the first member and the second member.

According to the fifth aspect, the conductors can be easily welded by extremely fine welding lines even if they are complicatedly arranged.

The welding method according to a sixth aspect of the present invention is characterized in that the first member or the second member further includes an insulator in the vicinity of the overlapping part.

According to the sixth aspect, it is possible to extremely restrict heat input of the welded part by the extremely fine welding lines, and therefore it is possible to weld the members without damaging the insulator.

The welding method according to a seventh aspect of the present invention is characterized in that the first member is a diaphragm, and the scheduled welding lines are set in an overlapping part of the first member and the second member.

According to the seventh aspect, it is possible to suppress welding distortion even in a thin plate while forming a welded part having desired welding area and welding shape.

The welding method according to an eighth aspect of the present invention is characterized in that the first member is a diaphragm, a sealing member is further included between the first member and the second member, and the scheduled welding lines are set in an outer circumferential edge of the first member.

According to the eighth aspect, it is possible to extremely restrict heat input of the welded part by the extremely fine welding lines, and therefore it is possible to weld the members without damaging the sealing member.

The welding method according to a ninth aspect of the present invention is characterized in that the first member includes a shaft part and a head part having a larger diameter than the shaft part, the second member includes a hole part fitted to the shaft part of the first member, and the scheduled welding lines are set in an outer circumferential edge of the head part of the first member and/or a boundary of the shaft part of the first member and the hole part of the second member.

According to the ninth aspect, it is possible to form a welded part having desired welding area and welding shape.

The welding method according to a tenth aspect of the present invention is characterized in that the first member includes a shaft part and a head part having a larger diameter than the shaft part, the second member includes a hole part fitted to the shaft part of the first member, an end part of the shaft part fitted into the hole part is enlarged in diameter, and the scheduled welding lines are set in an outer circumferential edge of the portion where the diameter is enlarged.

According to the tenth aspect, even if the shape of the portion where the diameter is enlarged is irregular, it is possible to easily weld an enlarged diameter part by welding lines annularly formed across the scheduled welding lines and along the scheduled welding lines.

The welding method according to an eleventh aspect of the present invention is characterized in that a sealing member is further included between the first member and the second member.

According to the eleventh aspect, it is possible to extremely restrict heat input of the welded part by the extremely fine welding lines, and therefore it is possible to weld the members without damaging the sealing member.

The welding method according to a twelfth aspect of the present invention is characterized in that the first member includes a male screw part and a head part having a larger diameter than the male screw part, the second member includes a female screw part threaded to the male screw part, and the scheduled welding lines are set in an outer circumferential edge of the head part of the first member and/or a boundary of the male screw part of the first member and the second member.

According to the twelfth aspect, it is possible to fix screws by forming a welded part having desired welding area and welding shape.

In order to solve the problem, a joining structure of a thirteenth aspect of the present invention is a structure in which at least a first member and a second member made of metals are joined by welding, the joining structure is characterized in that a joined part of the first member and the second member includes an annular welding line group in which welding lines having a predetermined length in a radial direction are lined up in a circumferential direction.

According to the thirteenth aspect, the annular welding line group in which the welding lines having a predetermined length are lined up in the circumferential direction can be formed so as to have desired shape and area. Moreover, even if welding distortion occurs, the welding distortion is resolved by being heated again by the adjacent welding lines, thereby capable of exhibiting more excellent welding strength and durability. Further, by an annular joined part, the metal joining structure can exhibit high strength and durability without directionality even if a force acts from any direction with respect to a welded part.

The metal joining structure according to a fourteenth aspect of the present invention is characterized in that, in the circumferential direction of the annular welding line group, the adjoining welding lines come into contact or overlap with each other.

According to the fourteenth aspect, adjoining welding marks are reinforced by overlapping with each other, and therefore the metal joining structure can exhibit high strength and durability.

The metal joining structure according to a fifteenth aspect of the present invention is characterized in that the first member and the second member are members of an annular thin plate which are alternately laminated, and an overlapping part of the adjoining first member and second member includes the annular welding line group.

According to the fifteenth aspect, even the thin plates can be joined by a joining structure having desired welding area and welding shape and having less welding distortion.

The metal joining structure according to a sixteenth aspect of the present invention is characterized in that the first member and the second member are conductors, and an overlapping part of the first member and the second member includes the annular welding line group.

According to the sixteenth aspect, even the conductors complicatedly arranged can be joined by a joining structure having desired welding area and welding shape and having less welding distortion.

The joining structure according to a seventeenth aspect of the present invention is characterized in that an insulator is further included in the vicinity of the overlapping part.

According to the seventeenth aspect, even if there is an insulating part in the vicinity of the welded part, by a joining structure having desired welding area and welding shape and having less welding distortion, the conductors can be joined without damaging the insulator while securing the distance with the insulator.

The metal joining structure according to an eighteenth aspect of the present invention is characterized in that the first member is a diaphragm, and an overlapping part of the first member and the second member includes the annular welding line group.

According to the eighteenth aspect, even the diaphragm with large deformation can be surely joined by a joining structure having desired welding area and welding shape and having less welding distortion.

The metal joining structure according to a nineteenth aspect of the present invention is characterized in that the first member is a diaphragm, a sealing member is further included between the first member and the second member, and an outer circumferential edge of the first member includes the annular welding line group.

According to the nineteenth aspect, even if there is the sealing member in the vicinity of the welded part, by a joining structure having desired welding area and welding shape and having less welding distortion, a high airtight joining structure can be achieved without damaging the sealing member while securing the distance with the sealing member.

The metal joining structure according to a twentieth aspect of the present invention is characterized in that the first member further includes a shaft part and a head part having a larger diameter than the shaft part, the second member further includes a hole part fitted to the shaft part of the first member, and the annular welding line group is included in an outer circumferential edge of the head part of the first member and/or a boundary of the shaft part of the first member and the hole part of the second member.

According to the twentieth aspect, even the conductors having a level difference by the head part and the shaft part and being complicatedly arranged can be joined by a joining structure having desired welding area and welding shape and having less welding distortion.

The metal joining structure according to a twenty-first aspect of the present invention is characterized in that the first member further includes a shaft part and a head part having a larger diameter than the shaft part, the second member further includes a hole part fitted to the shaft part of the first member, an end part of the shaft part fitted into the hole part further includes an enlarged diameter part, and an outer circumferential edge of the enlarged diameter part includes the annular welding line group.

According to the twenty-first aspect, even if an outer edge of the enlarged diameter part has an irregular shape, the members can be surely joined by a joining structure having desired welding area and welding shape and having less welding distortion.

The joining structure according to a twenty-second aspect of the present invention is characterized in that a sealing member is further included between the first member and the second member.

According to the twenty-second aspect, a joining structure securing airtightness can be achieved without damaging the sealing member.

The metal joining structure according to a twenty-third aspect of the present invention is characterized in that the first member includes a male screw part and a head part having a larger diameter than the male screw part, the second member includes a female screw part threaded to the male screw part, and the annular welding line group is included in an outer circumferential edge of the head part of the first member and/or a boundary of the male screw part of the first member and the second member.

According to the twenty-third aspect, it is possible to surely prevent rotation of the screws with respect to the thin plates.

### BRIEF DESCRIPTION OF DRAWINGS

FIG. 1 illustrates a structure of a metal bellows according to a first embodiment of the present invention, FIG. 1(a) is a plan view of the metal bellows, and FIG. 1(b) is an A-A sectional view of FIG. 1(a).

FIG. 2 is a diagram explaining a manufacturing process of the metal bellows.

FIG. 3 illustrates a welded part of the metal bellows, FIG. 3(a) illustrates an example of welding by irradiating a laser light while sequentially drawing a generally circular locus along welding lines, and FIG. 3 (b) illustrates an example of welding by increasing the density of the generally circular welding lines.

FIG. 4 is a diagram explaining a method of welding by irradiating a laser light while sequentially drawing a zigzag locus along the welding lines of a joined part.

FIG. 5 illustrates joining of metal plate conductors according to a second embodiment of the present invention, FIG. 5(a) illustrates an example of joining by superimposing the insulated conductors, and FIGS. 5(b) and 5(c) illustrate an example of joining three metal plates.

FIG. 6 illustrates joining of a diaphragm according to a third embodiment of the present invention, FIG. 6(a) is a plan view, and FIG. 6(b) illustrates an X-X section of FIG. 6(a).

FIG. 7 illustrates a modification of joining of the diaphragm according to the third embodiment, FIG. 7(a) is a plan view, and FIG. 7(b) illustrates a Y-Y section of FIG. 7(a).

FIG. 8 illustrates joining of a plug member according to a fourth embodiment of the present invention, FIG. 8(a) is a side sectional view, FIG. 8(b) is a view on arrow A in FIG. 8(a), FIG. 8(c) is a side sectional view of a modification, and FIG. 8(d) illustrates still another modification.

FIG. 9 illustrates joining of the plug member according to a fifth embodiment of the present invention, FIG. 9(a) is a side sectional view illustrating a state that the plug member is attached to a plate member, FIG. 9(b) illustrates a state that an end part of the plug member is caulked, and FIG. 9(c) is a view on arrow B in FIG. 9(b).

FIG. 10 illustrates joining of screw members according to a sixth embodiment of the present invention, FIG. 10(a) is a side sectional view, FIG. 10(b) is a view on arrow C in FIG. 10(a), and FIG. 10(c) is a view on arrow D of FIG. 10(a).

### DESCRIPTION OF EMBODIMENTS

### First Embodiment

Although embodiments of a metal bellows and a manufacturing method of a metal bellows according to the present invention will be described in detail with reference to the drawings, the present invention shall not be interpreted as being limited thereto, and a variety of changes, amendments, or improvements could be added based on the knowledge of a person skilled in the art without departing from the scope of the present invention.

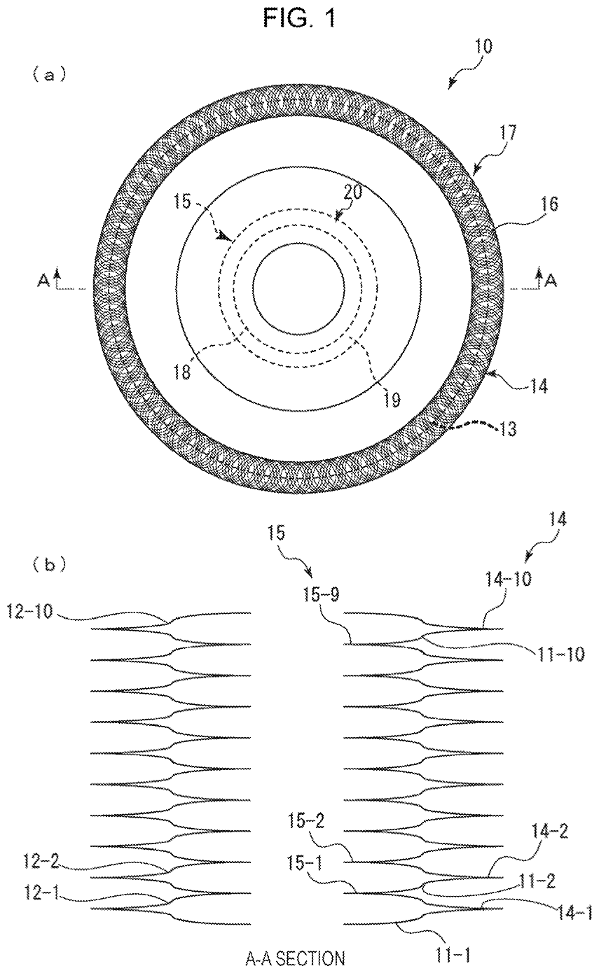

A metal bellows and a manufacturing method of a metal bellows according to the embodiments of the present invention will be described with reference to FIGS. 1 to 3. A metal bellows 10 has a first element member 11 (a first member according to the present invention) and a second element member 12 (a second member according to the present invention), and the first element member 11 and the second element member 12 are joined by laser welding of a joined part 14 of an end surface on an outer circumferential side or a joined part 15 of an end surface on an inner circumferential side of the first element member. Moreover, in an embodiment of FIG. 1, the first element member 11 consists of ten first element members 11-1, 11-2, . . . , 11-10, and also the second element member 12 consists of ten second element members 12-1, 12-2, . . . , 12-10. Then, the first element members 11-1, . . . , 11-10 and the second element members 12-1, . . . , 12-10 are assembled by alternately welding joined parts 15-1, . . . , 15-9 of the end surface on the inner circumferential side and joined parts 14-1, . . . , 14-10 of the end surface on the outer circumferential side of the respective element members which are alternately laminated and adjacent. In addition, the ten element members are laminated in FIG. 1, but the embodiment is not limited thereto, the end surfaces on the outer circumferential side maybe welded and joined by laminating the respective one of the first element member and the second element member. Moreover, in accordance with a required design condition, the lamination number of the element members may be 10 or less, or 10 or more.

The first element members 11-1, . . . , 11-10 and the second element members 12-1, 12-2, . . . , 12-10 are generally circular members having a hole in a center part, and made of various metals such as stainless steel, titanium alloy, copper alloy, and nickel alloy. The first element member is shaped into a member having a concave part on an inner diameter side where an axial height of an inner diameter part is lower than the axial height of an outer diameter part. The second element member is shaped into a member having a convex part on the inner diameter side where the axial height of the inner diameter part is higher than the axial height of the outer diameter part.

Although the first element member 11 and the second element member 12 are joined by laser welding, a laser light is not sufficiently absorbed with respect to a high reflective material such as copper alloy, and the members couldn't be efficiently welded. Usually, a green laser is used for welding copper alloy or the like. However, the green laser can't be sequentially irradiated, and has poor productivity. Moreover, as to the green laser, laser output has to be increased in welding because the emission time of laser is as short as a few msec, and when a thin bellows is welded at a high laser output, the joined parts 14, 15 are melted down and it is impossible to obtain an excellent joined part.

Thus, in the present invention, a single-mode fiber laser capable of sequential irradiation is used as laser. A single-mode fiber laser light whose laser beam intensity has one peak in an irradiated region can be sequentially irradiated by narrowing down the size of a beam spot to around several 10 μm to 100 μm and focusing the laser light output on one point, and therefore a heat gain in the beam spot can be secured without excessively increasing the laser output, and even the members whose thickness is thin like the element members of the metal bellows can be welded with low distortion. Further, welding can be done in a non-contact manner with a part to be welded, and therefore even narrow portions can be welded by complicate welding lines by sending a laser light.

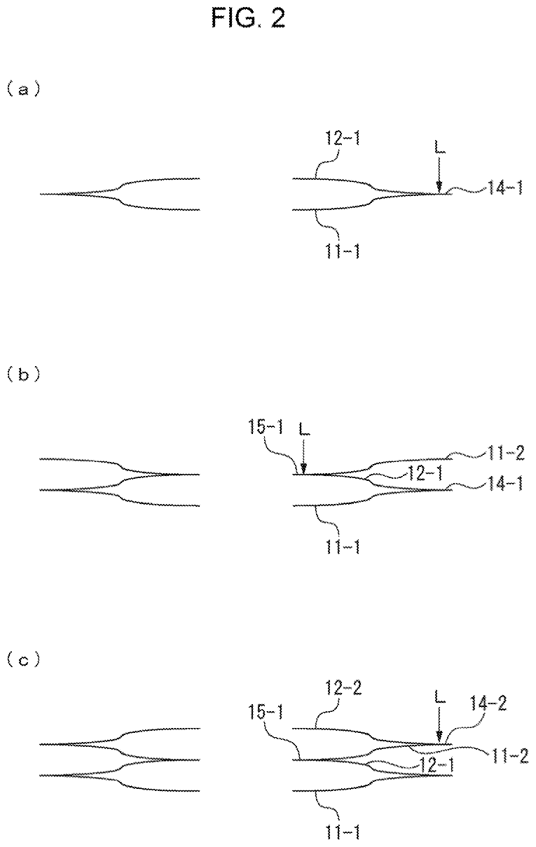

Next, a manufacturing procedure of a metal bellows will be described based on FIG. 2. In the present embodiment, as shown in FIGS. 1 and 2, one layer bellows is configured by the first element member and the second element member, and a metal bellows is configured by laminating it up to the tenth layer.

As shown in FIG. 2(a), the second element member 12-1 is laminated on the first element member 11-1 of the first layer. The first element member 11-1 and the second element member 12-1 are joined by irradiating a laser light L on the joined part 14-1, of the end surface on the outer circumferential side, of the first element member 11-1 and the second element member 12-1, and then assembling of the first layer element members is finished. Here, it is desirable that a spot radius of a laser beam light is smaller than a movement amount in an inner diameter direction or an outer diameter direction of the laser beam light vibrating across a scheduled welding line 13 (a maximum movement amount in one direction (the inner diameter direction or the outer diameter direction) vertical to the scheduled welding line 13 in the welding lines), and thereby there is no place where the laser light is always irradiated, and there is no fear that heat is excessively applied to a part of welding places.

Next, the second layer element members are assembled on the first layer element member. As shown in FIG. 2(b), the second layer first element member 11-2 is laminated on the first layer second element member 12-1. Then, by irradiating the laser light L on the joined part 15-1 of the end surface on the inner circumferential side of the first element member 11-2, the second element member 12-1 and the first element member 11-2 are joined.

Next, as shown in FIG. 2(c), the second element member 12-2 is laminated on the first element member 11-2 welded in the previous step. Then, by irradiating the laser light L on the joined part 14-2 of the end surface on the outer circumferential side of the second element member 12-2, the first element member 11-2 and the second element member 12-2 are joined, and then assembling of the element members up to the second layer is finished. By repeating this procedure and laminating the element members up to the tenth layer, assembling of the metal bellows is finished.

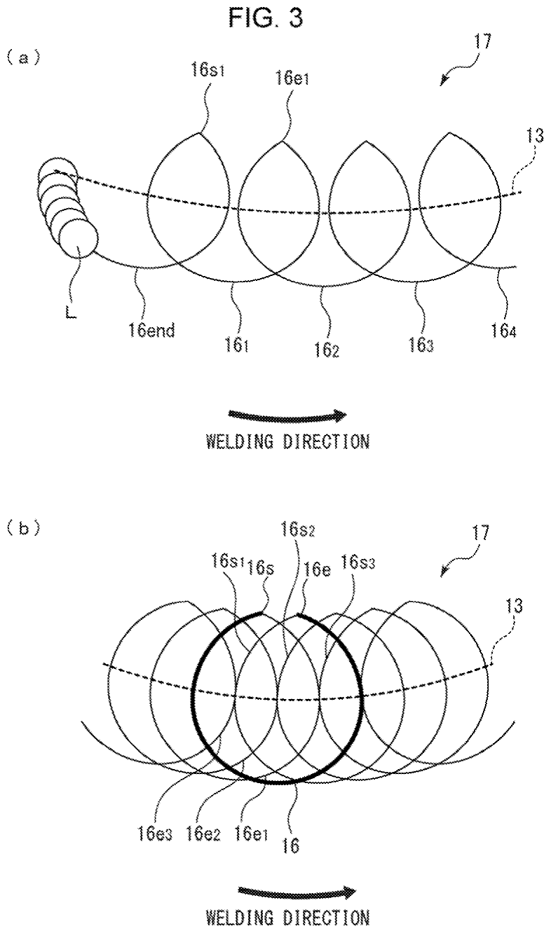

Next, welding line groups 17, 20 formed in the joined parts 14, 15 of the first element member 11 and the second element member 12 will be described. As shown in FIGS. 1 and 3, in the joined parts 14, 15, generally circular scheduled welding lines 13, 18 are set. Then, super-fine and arcuate welding lines 16, 19 having a predetermined length in a radial direction annularly range along the scheduled welding lines 13, 18 and adjacently in a circumferential direction and then formed as the annular welding line groups 17, 20. Specifically, the width of the welding lines is as extremely narrow as around 100 μm to 500 μm, and the radial length of the welding lines is formed into around 0.1 mm to 10 mm. The configuration of the annular welding line group 17 formed in the joined part 14 and the configuration of the annular welding line group 20 formed in the joined part 15 are the same, and therefore hereinafter, the annular welding line group 17 will be described. In addition, the scheduled welding lines 13, 18 are not limited to a circular shape as long as they have a closed annular shape.

As shown in FIG. 3(a), by sequentially irradiating a laser light while moving along the generally circular scheduled welding line 13 set in the joined part 14 and vibrating across the scheduled welding line 13, arcuate welding lines 16₁, 16₂, 16₃, 16₄, . . . , 16_{end} are formed, and the annular welding line group 17 is formed in such a manner that the welding lines annularly range adjacently in the circumferential direction. Moreover, the radial dimension of the arcuate welding line 16 is set so as to form the annular welding line group 17 having a welding area required for securing durability and airtightness of the metal bellows. Here, the annular welding line group 17 will be described focusing on the one welding line 16₁ among the group. If a welding direction of the annular welding line group 17 is counterclockwise rotation, the welding line 16₁ is welded in such a manner that a part of the welding line 16₂ adjacent to a terminal end part 16e1 side of the welding line 16₁ and a part of the welding line 16_{end} adjacent to a beginning end part 16s1 side overlap with each other.

In this manner, the welding line 16₁ has overlapping parts with the adjoining welding line 16₂ and welding line 16_{end}, thereby they are reinforced with each other and can disperse external force, and therefore it is possible to increase joining strength. Moreover, although the welding line 16₁ is rapidly cooled after welding and welding distortion remains, the welding line 16₁ has the overlapping parts with the adjoining welding line 16₂ and welding line 16_{end}, thereby the welding line 16₁ is heated again when the welding line 16₂ is welded, and therefore an effect to resolve welding distortion is also obtained.

Moreover, as shown in FIG. 3(b), the welding line 16 may have overlapping parts with more adjoining welding lines. For example, welding may be done in such a manner that three welding lines 16s1, 16s2, 16s3 adjacent to the terminal end part 16e side of the welding line 16 and three welding lines 16e1, 16e2, 16e3 adjacent to the beginning end part 16s side of the welding line 16 intersect the welding line 16. Accordingly, the welding line 16 forms the overlapping parts with six adjoining welding lines 16s1, 16s2, 16s3, 16e1, 16e2, 16e3, thereby the welding lines 16, 16s1, 16s2, 16s3, 16e1, 16e2, 16e3 are intertwined in the form of mesh and reinforced with each other, and therefore it is possible to further increase joining strength. Moreover, a plurality of adjoining welding lines 16, 16s1, 16s2, 16s3, 16e1, 16e2, 16e3 are heated again by mutual welding heat, and therefore it is possible to resolve welding distortion.

In FIG. 3(b), the welding line 16 forms the overlapping parts with the six adjoining welding lines 16s1, 16s2, 16s3, 16e1, 16e2, 16e3, but can be intersected with more adjoining welding lines. However, even if the intersection number is increased to twelve or more, adhesion strength of the welded part is hardly increased.

As described above, in the metal bellows and the welding method of the metal bellows, the laser light L forms the welding lines 16, 19 while moving along the scheduled welding lines 13, 18 from an axial direction, that is, a laminating direction of the first element member 11 and the second element member 12 and vibrating across the scheduled welding lines 13, 18, and therefore a radial width of the welding lines 16, 19 can be set freely, and even the extremely fine welding lines 16, 19 can form a welded part having desired shape and area by ranging the welding lines 16, 19 in the circumferential direction. Moreover, in the joined parts 14, 15, the welding lines 16, 19 overlap with each other, thereby the element members 11, 12 are joined at high adhesion strength even if external force acts from any direction, and welding distortion can be resolved by being heated again in the process in which the welding lines overlap with each other in many layers.

Besides, it is desirable that the adjoining welding marks come into contact or overlap with each other in a direction parallel to the scheduled welding lines, that is, in the circumferential direction, thereby the whole joined part is welded and a uniform welding depth can be obtained, and further, the whole joined part is heated again, and therefore welding distortion in the whole joined part can be resolved. In an outer circumferential edge or an inner circumferential edge of the annular welding line groups 17, 20, in an annular region having a welding line width respectively to the outside and the inside from a circumferential edge, that is, in an annular region in which the outer circumferential edge or the inner circumferential edge plus or minus the welding line width, one welding line and the welding line adjacent to the one welding line come into contact or overlap with each other, thereby the annular welding line groups 17, 20 can closely form the planar joined parts 14, 15. In addition, if the welding line width is changed, a maximum welding width among the welding line widths is adopted.

Hereinbefore, the embodiment of the present invention has been described with reference to the drawings, but the specific configuration is not limited to the embodiment. The present invention also includes any changes or additions made within a scope that does not depart from the spirit of the present invention.

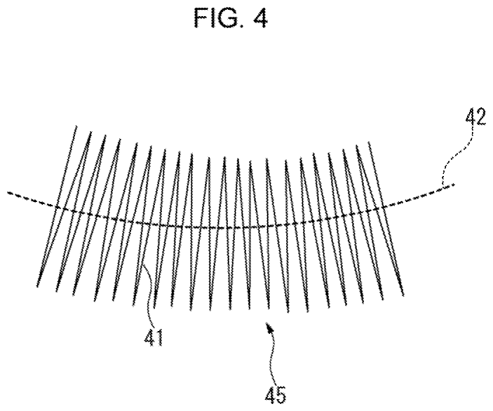

In the above embodiment, the joined parts 14, 15 form the annular welding line groups 17, 20 by using the arcuate welding lines 16, 19, but the embodiment is not limited thereto. For example, as shown in FIG. 4, super-fine and linear welding lines 41 having a predetermined length in the radial direction may annularly range along a scheduled welding line 42 and adjacently in the circumferential direction and then form an annular welding line group 45.

### Second Embodiment

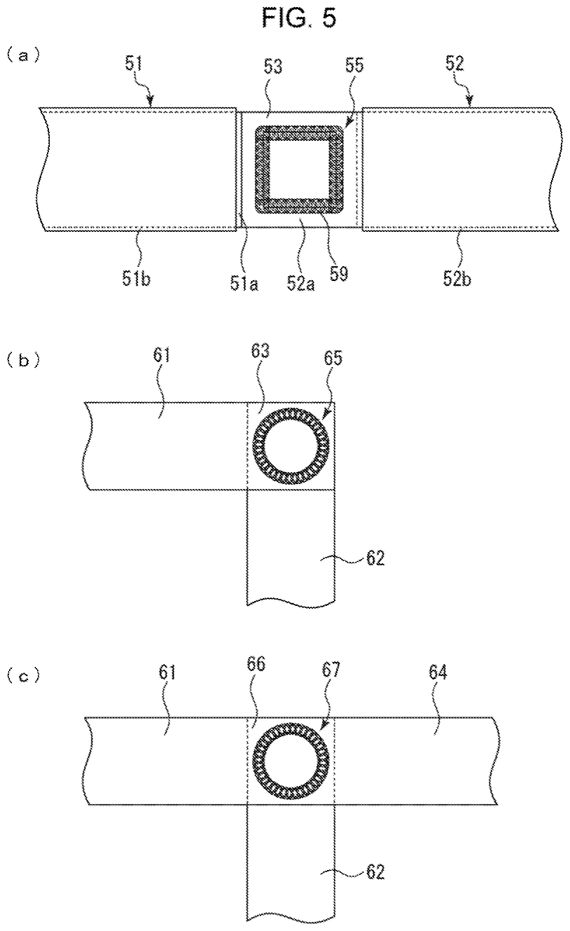

Next, a metal joining structure and a metal welding method according to a second embodiment will be described with reference to FIG. 5. Although the above embodiment describes the metal bellows and the welding method of the metal bellows, the invention according to the second embodiment is for joining the superimposed metal plates. In addition, the description overlapping with the above embodiment will be omitted.

FIG. 5(a) shows a joining structure of insulated conductors 51, 52 constituting an electric circuit. In the insulated conductor 51 (the first member according to the present invention) and the insulated conductor 52 (the second member according to the present invention), conductors 51a, 52a are insulated respectively by insulating coatings 51b, 52b. The conductors are joined by irradiating the laser light L on an overlapping part 53 formed by removing the insulating coatings 51b, 52b and superimposing the conductors, and forming an annular welding line group 55. In the above first embodiment, the annular welding line group is formed by adjacently forming the welding lines along the generally circular scheduled welding line. However, as long as the scheduled welding line has a closed annular shape, an annular welding line group in a rectangular shape along a rectangular scheduled welding line 59 as shown in FIG. 5(a) maybe formed. For example, if a shape of the overlapping part of the laminated metal plates is a triangle, an annular welding line group in a triangular shape may be formed according to the shape of the overlapping part.

By a single-mode fiber laser light used in the present invention, welding can be done without increasing a heat gain of the welded part by narrowing down the size of a beam spot to around 10 μm to 100 μm and focusing the laser light output on one point. Accordingly, even if the welded part and an insulator are approaching, by using the sufficiently narrowed laser light with respect to a gap dimension of the welded part and the insulator, welding can be done without damaging the insulator of the insulated conductor.

Moreover, in the above embodiment, two metals are superimposed and joined, but a joining structure of three or four or more metals may be possible. For example, as shown in FIG. 5(b), an overlapping part 63 formed by superimposing a metal plate 61 and a metal plate 62 is joined by forming an annular welding line group 65 by a laser light, and further an overlapping part 66 formed by superimposing a metal plate 64 is joined by forming an annular welding line group 67 by a laser light, thereby capable of obtaining a three layered joining structure. Alternatively, three or four or more metals may be joined by superimposing them and simultaneously forming annular welding line groups by a laser light.

Further, the conductors 51, 52 of FIG. 5(a) may have a sterically folded three-dimensional shape in addition to a two-dimensional linear shape. For example, the conductors 51, 52 may have a bent shape in the form of a crank, and the insulated conductors 51, 52 may be arranged in a standing condition on both sides of the overlapping part 53. Welding can be done in a non-contact manner with the overlapping part 53 by a laser light, and therefore even if the insulated conductors 51, 52 are arranged in a standing condition on both sides thereof, the overlapping part can be joined by sending a laser light and forming the annular welding line group 55.

In the second embodiment, the joining structure and the welding method of the conductors made of copper, copper alloy, aluminum, aluminum alloy or the like have been described. However, not only the conductors, but also metal plates made of iron and steel materials such as iron, steel, and stainless steel, or non-ferrous metals such as titanium may be applied to joining, or the present invention may be applied to joining of dissimilar metals. Moreover, the present invention can be applied to not only welding of plate materials, but also welding of wire rods or the wire rod and the plate material.

### Third Embodiment

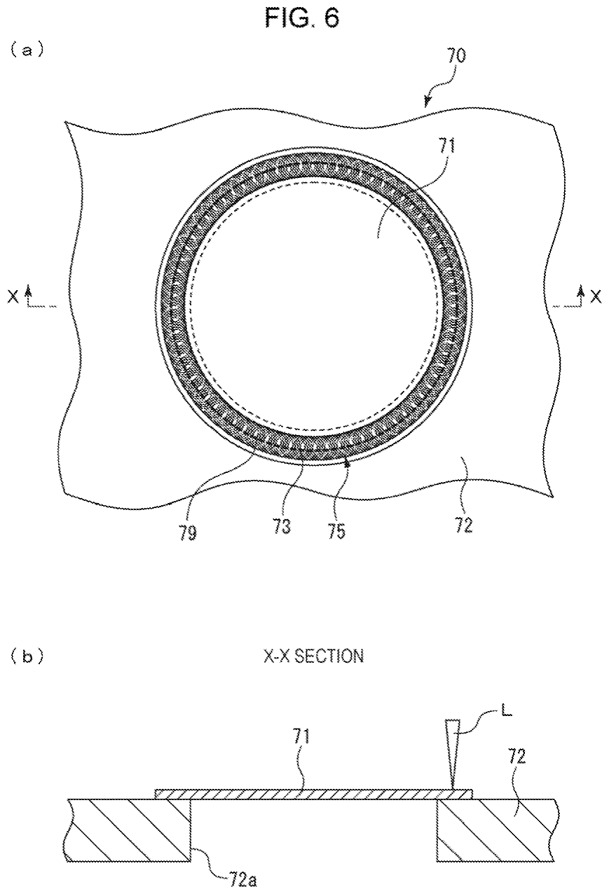

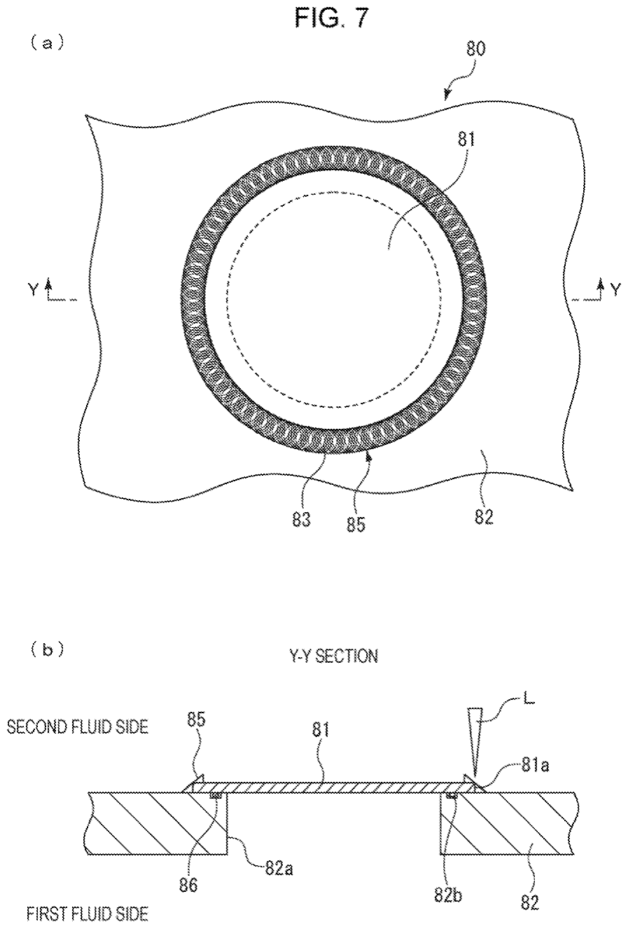

The invention according to a third embodiment is a joining structure and a welding method of a metal diaphragm and will be described with reference to FIGS. 6 and 7. In addition, the description overlapping with the above embodiments will be omitted. In addition, in the following embodiment, metals mean iron and steel materials such as iron, steel, and stainless steel, or non-ferrous metals such as aluminum, copper, and titanium, and as long as they are weldable metals, the joining structure and the welding method of the present invention can be applied thereto.

As shown in FIG. 6, a diaphragm 71 (the first member according to the present invention) is an elastic thin film made of a metal plate of a generally circular thin plate. The diaphragm 71 is attached so as to close a hole part 72a provided in a metallic plate member 72 (the second member according to the present invention), and is deformed in a plate thickness direction according to a difference of external forces generated in front and back of the diaphragm 71. Particularly, the joining structure and the welding method of the present invention is suitable for joining of the diaphragm 71 on which external force acts repeatedly and the plate member 72.

As shown in FIG. 6, the diaphragm 71 and the metallic plate member 72 are joined by irradiating the laser light L along a scheduled welding line 79 set in an overlapping part 73 of the plate member 72 and the diaphragm 71 attached so as to close the hole part 72a provided in the plate member 72 and forming an annular welding line group 75. Accordingly, even if a force acts on the welded part from any direction, the diaphragm 71 can be firmly fixed to the plate member 72.

Moreover, in a case where airtightness is required like a diaphragm partitioning a first fluid side (for example, a liquid side) and a second fluid side (for example, a gas side), as shown in FIG. 7, a sealing member 86 is arranged in a groove part 82b formed around a hole part 82a of a metallic plate member 82, and the laser light L is irradiated along an outer edge part 81a of a diaphragm 81 attached almost concentrically to the hole part 82a. That is, the outer edge part 81a of the diaphragm 81 is set to a scheduled welding line. Then, welding is done in such a manner that super-fine welding lines 83 having a predetermined length in the radial direction sequentially range along the outer edge part 81a of the diaphragm 81 and adjacently in the circumferential direction and form an annular welding line group 85. By irradiating laser along the outer edge part 81a of the diaphragm 81, it is possible to reduce a thermal effect by the laser light L with respect to the sealing member 86 by securing the gap between the laser light L and the sealing member 86, and it is possible to form the diaphragm 81 having airtightness.

### Fourth Embodiment

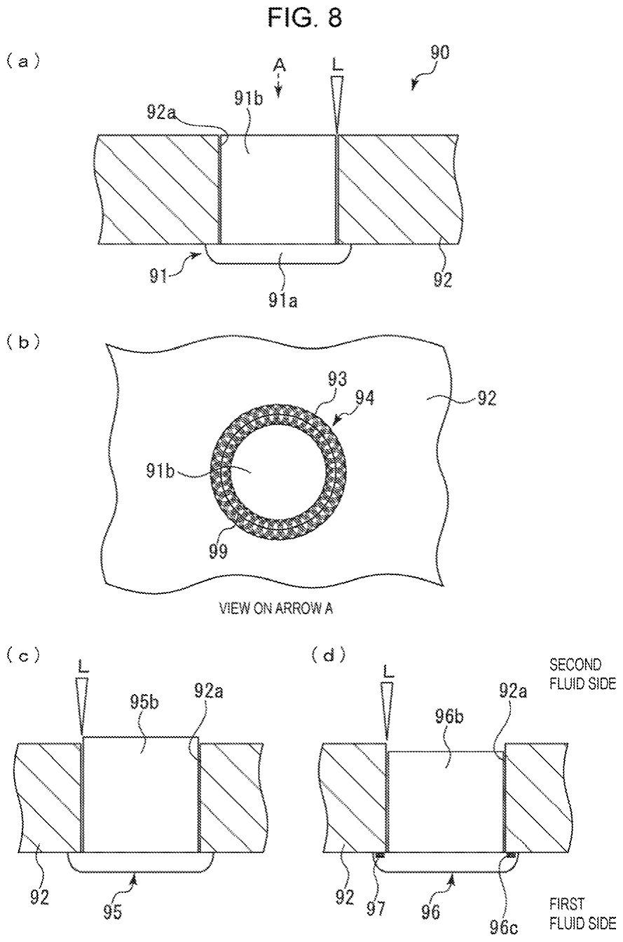

The invention according to a fourth embodiment is a joining structure and a welding method of a metallic plug member and will be described with reference to FIG. 8. In addition, the description overlapping with the above embodiments will be omitted.

As shown in FIGS. 8(a) and 8(b), a plug member 91 (the first member according to the present invention) consists of a shaft part 91b and a head part 91a having a larger diameter than the shaft part 91b. The shaft part 91b of the plug member 91 is inserted in a hole part 92a provided in a metallic plate member 92 (the second member according to the present invention). A scheduled welding line 99 is set in a boundary of the shaft part 91b of the plug member 91 and the hole part 92a of the plate member 92. Then, the members are joined by forming an annular welding line group 94 in which super-fine welding lines 93 having a predetermined length in the radial direction range along the boundary of the shaft part 91b and the hole part 92a and adjacently in the circumferential direction. Accordingly, the plug member 91 is fixed to the plate member 92. In addition, the scheduled welding line may be set in an outer circumferential edge of the head part 91a of the plug member 91 and form an annular welding line group by irradiating a laser light along the outer circumferential edge of the head part 91a, or may form an annular welding line group by irradiating a laser light along both the outer circumferential edge of the head part 91a of the plug member 91 and the boundary of the shaft part 91b and the hole part 92a of the plate member 92.

Moreover, as shown in FIG. 8(c), a shaft part 95b of a plug member 95 inserted in the hole part 92a of the plate member 92 may protrude from a surface of the plate member 92, and as shown in FIG. 8(d), a shaft part 96b of a plug member 96 inserted in the hole part 92a of the plate member 92 may recede from the surface of the plate member 92. Even if there is a level difference in boundaries, being scheduled welding lines, of the shaft parts 95b, 96b and the hole part 92a of the plate member 92, the plug members 95, 96 can be easily fixed by an annular welding line group 94.

Further, in a case where the plug member partitions a first fluid side (for example, a liquid side) and a second fluid side (for example, a gas side), as shown in FIG. 8(d), a sealing member 97 may be arranged in the plug member 96.

### Fifth Embodiment

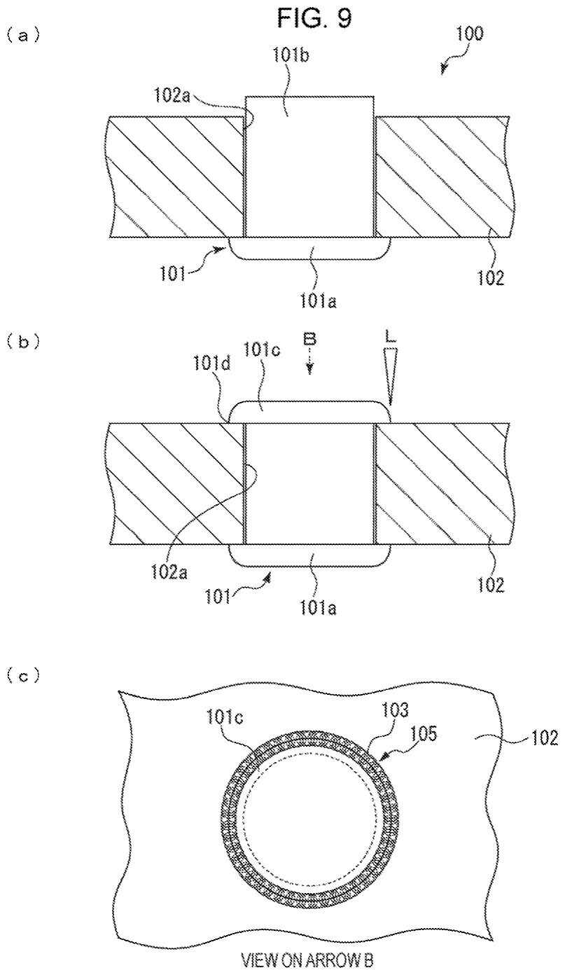

The invention according to a fifth embodiment is a joining structure for electrically joining a plate member and a calking terminal, and a welding method, and will be described with reference to FIG. 9. In addition, the description overlapping with the above embodiments will be omitted.

As shown in FIG. 9(a), a calking terminal 101 (the first member according to the present invention) consists of a shaft part 101b and a head part 101a having a larger diameter than the shaft part 101b. The shaft part 101b of the calking terminal 101 is inserted in a hole part 102a provided in a metallic plate member 102 (the second member according to the present invention). Next, as shown in FIG. 9(b), an end part of the shaft part 101b of the calking terminal 101 is calked and is enlarged in diameter of around a few mm to 10 mm. Then, an outer circumferential edge 101d of an enlarged diameter part 101c is set as a scheduled welding line, and welding is done so as to form an annular welding line group 105 in which super-fine welding lines 103 having a predetermined length in the radial direction range along the outer circumferential 101d (the scheduled welding line) and adjacently in the circumferential direction. Accordingly, the calking terminal 101 and the plate member 102 are electrically joined, and contact resistance between the calking terminal 101 and the plate member 102 is reduced. Usually, the outer circumferential edge 101d of the enlarged diameter part 101c is often enlarged in diameter not into a circular shape but into a distorted shape. However, even if the outer circumferential edge of the calked part is distorted, the welding lines 103 having a predetermined length in the radial direction annularly range adjacently in the circumferential direction, thereby the enlarged diameter part 101c of the calking terminal 101 and the plate member 102 are surely electrically joined. In addition, although the calking terminal 101 is solid, a calking terminal having hollow shaft part and head part may be possible.

### Sixth Embodiment

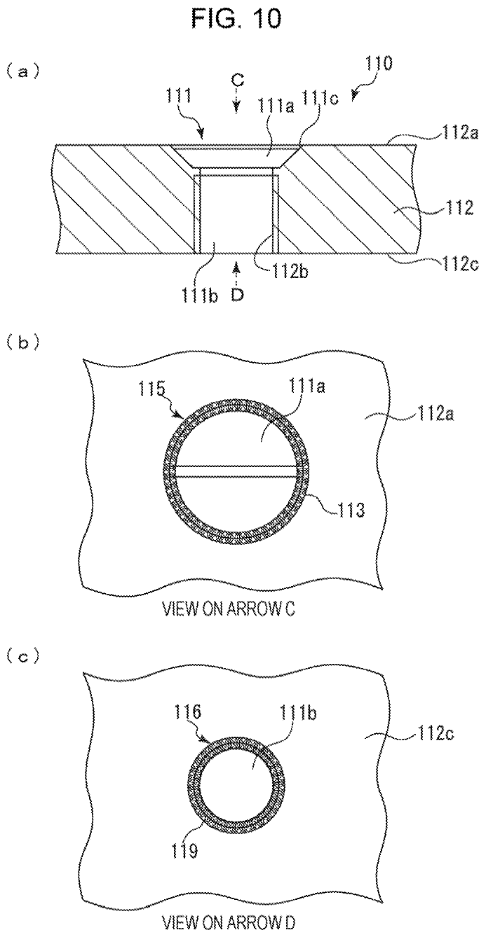

The invention according to a sixth embodiment is a joining structure for preventing rotation of a screw member which fixes a thin plate, and a welding method, and will be described with reference to FIG. 10. In addition, the description overlapping with the above embodiments will be omitted.

As shown in FIG. 10(a), a screw member 111 (the first member according to the present invention) consists of a male screw part 111b and a head part 111a having a larger diameter than the male screw part 111b. The male screw part 111b of the screw member 111 is threaded to a female screw part 112b provided in a metallic plate member 112 (the second member according to the present invention). Next, as shown in FIG. 10(b), an outer circumferential edge 111c of a head part 111a of the screw member 111 is set as a scheduled welding line, and super-fine welding lines 113 having a predetermined length in the radial direction on an end surface 112a of the plate member 112 form an annular welding line group 115 along the outer circumferential edge 111c of the head part 111a. The width of the welding line 113 is 100 μm to 500 μm, and even in a case of the screw member 111 which fixes the plate member 112 of around 0.1 mm to a few mm, it is possible to prevent rotation of the screw member 111 without distorting the thin plate member 112. Further, it is possible to prevent fluid leakage out of the screw parts.

Moreover, as shown in FIG. 10(c), a scheduled welding line 119 is set in a boundary of the male screw part 111b of the screw member 111 and the end surface 112c of the plate member 112, and an annular welding line group is formed by irradiating a laser light, thereby rotation of the screw member 111 may be prevented.

Hereinbefore, the embodiments of the present invention have been described with reference to the drawings, but the specific configuration is not limited to the embodiments. The present invention also includes any changes or additions made within a scope that does not depart from the spirit of the present invention.

For example, in the above embodiments, the scheduled welding line is circular or rectangular, but is not limited thereto as long as it has a closed annular shape. For example, the scheduled welding line may be an elliptical, triangular, or polygonal scheduled welding line, and an elliptical, triangular, or polygonal welding line group may be formed.

### REFERENCE SIGNS LIST

10: Metal bellows
11: First element member
12: Second element member
13: Scheduled welding line
14: Joined part
15: Joined part
16: Welding line
17: Annular welding line groups
18: Scheduled welding line
19: Welding line
20: Annular welding line group
41: Welding line
42: Scheduled welding line
45: Welding line group
55: Welding line group
66: Welding line group
67: Welding line group
L: Laser light

1. A metal welding method for joining at least a first member and a second member made of metals by using a fiber laser welding means, characterized in that
the welding means forms welding lines by sequentially irradiating a laser light while moving along annular scheduled welding lines and vibrating across the scheduled welding lines.

2. The metal welding method according to claim 1, characterized in that the welding means is a single-mode fiber laser.

3. The metal welding method according to claim 1, characterized in that, in a direction along the scheduled welding lines, the adjoining welding lines come into contact or overlap with each other.

4. The welding method according to claim 1, characterized in that the first member and the second member are members of an annular thin plate which are alternately laminated, and the scheduled welding lines are set in an overlapping part of the adjoining first member and second member.

5. The welding method according to claim 1, characterized in that the first member and the second member are conductors, and the scheduled welding lines are set in an overlapping part of the first member and the second member.

6. The welding method according to claim 5, characterized in that the first member or the second member further includes an insulator in the vicinity of the overlapping part.

7. The welding method according to claim 1, characterized in that the first member is a diaphragm, and the scheduled welding lines are set in an overlapping part of the first member and the second member.

8. The welding method according to claim 1, characterized in that the first member is a diaphragm, a sealing member is further included between the first member and the second member, and the scheduled welding lines are set in an outer circumferential edge of the first member.

9. The welding method according to claim 1, characterized in that the first member includes a shaft part and a head part having a larger diameter than the shaft part, the second member includes a hole part fitted to the shaft part of the first member, and the scheduled welding lines are set in an outer circumferential edge of the head part of the first member and/or a boundary of the shaft part of the first member and the hole part of the second member.

10. The welding method according to claim 1, characterized in that the first member includes a shaft part and a head part having a larger diameter than the shaft part, the second member includes a hole part fitted to the shaft part of the first member, an end part of the shaft part fitted into the hole part is enlarged in diameter, and the scheduled welding lines are set in an outer circumferential edge of the portion where the diameter is enlarged.

11. The welding method according to claim 9, characterized in that a sealing member is further included between the first member and the second member.

12. The welding method according to claim 1, characterized in that the first member includes a male screw part and a head part having a larger diameter than the male screw part, the second member includes a female screw part threaded to the male screw part, and the scheduled welding lines are set in an outer circumferential edge of the head part of the first member and/or a boundary of the male screw part of the first member and the second member.

13. A metal joining structure in which at least a first member and a second member made of metals are joined by welding, characterized in that
a joined part of the first member and the second member includes an annular welding line group in which welding lines having a predetermined length in a radial direction are lined up in a circumferential direction.

14. The metal joining structure according to claim 13, characterized in that, in the circumferential direction of the annular welding line group, the adjoining welding lines come into contact or overlap with each other.

15. The metal joining structure according to claim 13, characterized in that the first member and the second member are members of an annular thin plate which are alternately laminated, and an overlapping part of the adjoining first member and second member includes the annular welding line group.

16. The metal joining structure according to claim 13, characterized in that the first member and the second member are conductors, and an overlapping part of the first member and the second member includes the annular welding line group.

17. The joining structure according to claim 16, characterized in that an insulator is further included in the vicinity of the overlapping part.

18. The metal joining structure according to claim 13, characterized in that the first member is a diaphragm, and an overlapping part of the first member and the second member includes the annular welding line group.

19. The metal joining structure according to claim 13, characterized in that the first member is a diaphragm, a sealing member is further included between the first member and the second member, and an outer circumferential edge of the first member includes the annular welding line group.

20. The metal joining structure according to claim 13, characterized in that the first member further includes a shaft part and a head part having a larger diameter than the shaft part, the second member further includes a hole part fitted to the shaft part of the first member, and the annular welding line group is included in an outer circumferential edge of the head part of the first member and/or a boundary of the shaft part of the first member and the hole part of the second member.

21. The metal joining structure according to claim 13, characterized in that the first member further includes a shaft part and a head part having a larger diameter than the shaft part, the second member further includes a hole part fitted to the shaft part of the first member, an end part of the shaft part fitted into the hole part further includes an enlarged diameter part, and an outer circumferential edge of the enlarged diameter part includes the annular welding line group.

22. The joining structure according to claim 20, characterized in that a sealing member is further included between the first member and the second member.

23. The metal joining structure according to claim 13, characterized in that the first member includes a male screw part and a head part having a larger diameter than the male screw part, the second member includes a female screw part threaded to the male screw part, and the annular welding line group is included in an outer circumferential edge of the head part of the first member and/or a boundary of the male screw part of the first member and the second member.
